(19) United States
(12) Patent Application Publication
(10) Pub. No.: US 2020/0323611 A1
(43) Pub. Date: Oct. 15, 2020

(54) Dental Apparatus For Restricting Tongue Movement During Examinations And Procedures

(71) Applicant: Amylyn Carter, Reno, NV (US)

(72) Inventor: Amylyn Carter, Reno, NV (US)

(21) Appl. No.: 16/914,049

(22) Filed: Jun. 26, 2020

(51) Int. Cl. A61C 5/90

(52) U.S. Cl. CPC A61C 5/90

(57) ABSTRACT

An apparatus for restricting tongue movement during a dental procedure comprises a base for positioning the apparatus behind a lower set of teeth on a lower jaw within an oral cavity, a first wing for restricting movement of a tongue positioned vertically, and a second vertically positioned wing that also restricts movement of the tongue in coordination with the first wing. The herein disclosed dental apparatus is intended to be used during dental examinations or dental procedures when it is advantageous for the dental professional to restrict movement of the patient's tongue so that the tongue does not interfere with the procedure. In a preferred embodiment, at least the base of the dental apparatus is formed of a material that is able to absorb saliva and thus provide an additional moisture-wicking advantage to keep a portion of the oral cavity drier and relatively free of saliva, blood, or water. In a preferred embodiment, all components of the herein disclosed dental apparatus are formed of disposable materials.

### SUMMARY OF THE INVENTION

The present invention is generally related to dental and/or medical apparatus and devices, and more particularly related to a dental apparatus for restricting tongue movement during examinations and procedures. An apparatus for restricting tongue movement during a dental procedure comprises a base for positioning the apparatus behind a lower set of teeth on a lower jaw within an oral cavity, a first wing for restricting movement of a tongue positioned vertically, and a second vertically positioned wing that also restricts movement of the tongue in coordination with the first wing.

The herein disclosed dental apparatus is intended to be used during dental examinations or dental procedures when it is advantageous for the dental professional to restrict movement of the patient's tongue so that the tongue does not interfere with the procedure. In a preferred embodiment, at least the base of the dental apparatus is formed of a material that is able to absorb saliva and thus provide an additional moisture-wicking advantage to keep a portion of the oral cavity drier. In certain alternative embodiments, the base may include an internal mechanism or structure formed of a rigid material such as aluminum. The internal rigid structure can provide additional structural support for the dental apparatus by assisting to maintain a U-shape that conforms to a patient's oral cavity.

In a preferred embodiment, all components of the herein disclosed dental apparatus are formed of disposable materials. A disposable dental apparatus is advantageous in that there is no time, cost, or hygiene concerns associated with cleaning the apparatus—after use, the dental apparatus is not intended to be cleaned but instead may be disposed of using standard office waste procedures. For this specification, disposable materials are materials that are relatively inexpensive and will not cause hazardous waste issues when disposed of after use. Aluminum is considered a disposable medical (or dental) grade material that can be manufactured inexpensively enough to be a single-use item that is intended to be disposed of after a single use with a patient. Thus, an embodiment of the dental apparatus that utilizes an internal aluminum structure to, for example, provide improved stability or to retain a shape, may be disposable and may be considered formed entirely of disposable materials. A dental apparatus using an internal aluminum structure may be disposed of through standard waste procedures at a dental office such as depositing in a sharps container or in a biohazard bin.

A preferred embodiment of the present invention comprises: a base of flexible material capable of bending to form a U-shape for positioning the apparatus behind a lower set of teeth on a lower jaw within an oral cavity, wherein the base is cylindrical in shape; a first wing for restricting movement of a tongue and formed of a wing flexible material, wherein the first wing is positioned in a vertical orientation to partially provide a barrier in coordination with a second wing between the lower set of teeth and the tongue and wherein a lower edge of the first wing is anchored to the base to secure the vertical orientation; and the second wing restricting movement of the tongue and formed of the wing flexible material, wherein the second wing is positioned in a vertical orientation to partially provide the barrier in coordination with the first wing between the lower set of teeth and the tongue and wherein a lower edge of the second wing is anchored to the base to secure the vertical orientation. In certain embodiments, the first wing may overlap with the second wing so that the second wing is also anchored to the first wing. In alternative embodiments, the first wing may attach to the second wing to form a contiguous (or combined) wing structure that provides a barrier between the lower set of teeth and the tongue.

A primary purpose of the present invention is to provide an elegant, inexpensive, disposable, and easy to use dental apparatus for restricting tongue movement during dental examinations and procedures. The herein disclosed dental apparatus is a useful improvement over more complicated tongue restricting and saliva suction devices because it utilizes a simplistic design having a small number of components that fit together neatly. The dental apparatus is soft to the touch because of the materials forming the components, because the components are rounded in shape, and because the components fit together in an overlapping and/or contiguous configuration. And the dental apparatus is disposable because it may be made of disposable materials that can absorb bodily fluids from a patient and be safely discarded without requiring expensive and risky sterilization of the device after the procedure.

### CROSS-REFERENCES TO RELATED APPLICATIONS

No applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Dental examinations and many dental procedures benefit greatly when the patient's tongue is positioned in a retracted position and restricted from free movement that may interfere with the dental professional's work. Accordingly, devices have been developed that place the tongue in a reward or retracted position and thereafter restrict movement of the tongue within the oral cavity. These devices may additionally provide some level of suction to keep the operating field within the oral cavity relatively dry and free of saliva, blood, and/or water that may otherwise accumulate during a procedure.

But the presently available dental devices are complicated and expensive because they are formed of a myriad of components, many of which are metal and so must be sterilized after the procedure. The devices are also not comfortable for the patient because of the multiple metal components forming pointed or rigid edges that may irritate the oral cavity. They have many drawbacks.

It would therefore be advantageous to provide a dental apparatus that avoids the complications of the presently available solutions. The herein disclosed dental apparatus provides just such a simplistic, disposable, inexpensive to manufacture, and comfortable dental device that provides a vastly improved apparatus for restricting tongue movement.

### BRIEF DESCRIPTION OF THE SEVERAL VIEWS OF THE DRAWING

FIG. 1 illustrates an isometric view of the herein disclosed dental apparatus for restricting tongue movement during examination and procedures, wherein the dental apparatus is positioned for use on a lower jaw behind a set of lower teeth, in accordance with an exemplary embodiment of the present invention; and

FIG. 2 illustrates a top-down view of the herein disclosed dental apparatus for restricting tongue movement during examination and procedures, wherein the dental apparatus is positioned for use on a lower jaw behind a set of lower teeth, in accordance with an exemplary embodiment of the present invention and alternative embodiments of the present invention.

### DETAILED DESCRIPTION OF THE INVENTION

The present invention is an apparatus for restricting tongue movement during a dental procedure and comprises base 110 for positioning the apparatus behind lower set of teeth 1 on a lower jaw within an oral cavity, first wing 120 for restricting movement of a tongue positioned vertically, and second vertically positioned wing 130 that also restricts movement of the tongue in coordination with first wing 120.

Throughout this specification, the herein disclosed dental apparatus will mostly be described as being formed of disposable materials and therefore the dental apparatus is, in most embodiments, fully disposable through a dental or medical office's standard waste disposal procedures. But the dental apparatus described herein can alternatively be formed of alternative materials that may not be fully disposable. For example, the dental apparatus may be formed of non-porous material that does not absorb patient fluids and therefore may be re-used for that patient or subsequent patients. This alternative non-disposable embodiment is intended to be included in this specification as a non-preferred embodiment of the present invention. As described herein, certain embodiments of the dental apparatus may include a rigid structure positioned within the base to provide increased structural support. The rigid structure can be formed of aluminum, which is considered a disposable material in the medical and/or dental fields.

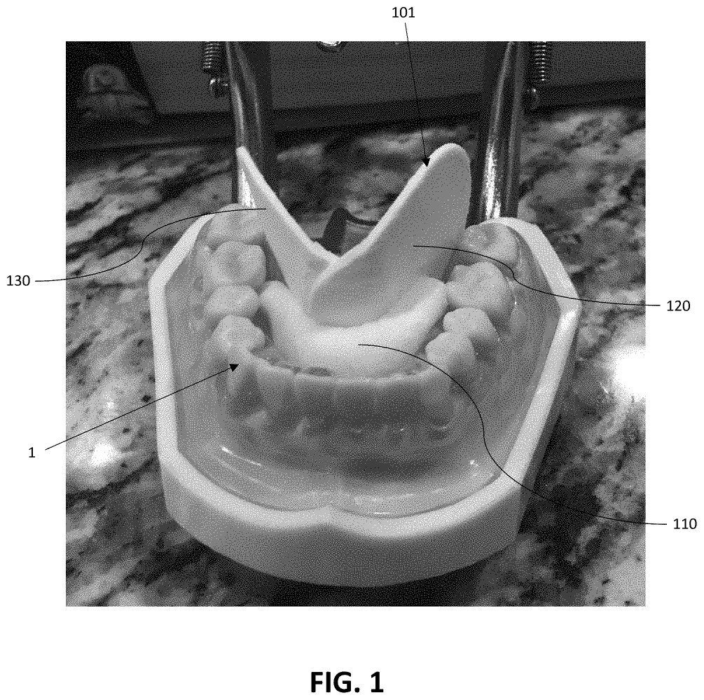

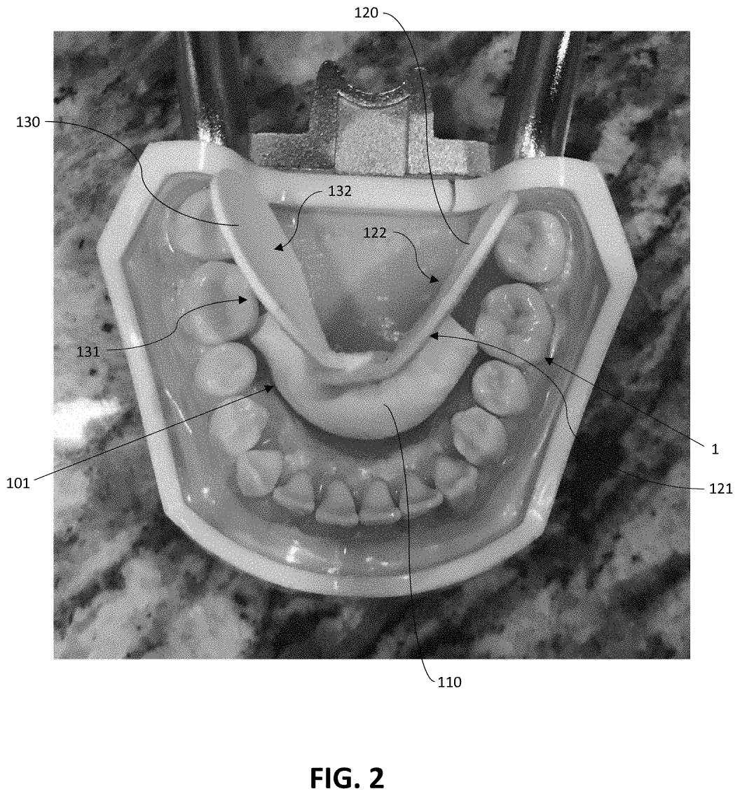

Referring to FIG. 1 and FIG. 2, dental apparatus 101 for restricting tongue movement during dental procedures is positioned within lower set of teeth 1 within a lower jaw. The entirety of FIG. 1 represents a portion of a patient's oral cavity. Lower set of teeth 1 may be in any type of patient's mouth, including a non-human patient such as an animal.

Dental apparatus 101 includes base 110 that is capable of bending to form a U-shape as seen in FIG. 1 and is more apparent in the top-down view in FIG. 2. In a preferred embodiment, base 110 is cylindrical; for example, the base may be a rolled cotton and/or a non-woven material that may be formed substantially as a cylinder and bent into a U-shape either at the manufacturing stage or during use. Base 110 may, in certain embodiments, taper at one or both ends so that base 110 has a larger diameter in proximity to one or more incisor teeth of lower set of teeth 1 and smaller diameter in proximity to one or more molar teeth of lower set of teeth 1. The base may be formed of a flexible and disposable medical grade material. For example, the base may be formed of cellulose, cotton, and/or medical grade foam. In certain embodiments, base 110 may include an internal rigid structure that provides increased structural support for the U-shape of base 110. For example, an aluminum member may be positioned within base 110 and span substantially from one end of base 110 to another end of base 110. The aluminum member may assist the dental apparatus to maintain the desired U-shape necessary to conform to the patient's oral cavity.

Base 110 may be formed of any material that is pliable enough to form a U-shape as necessary to be positioned behind lower set of teeth 1, as seen in FIG. 1 and FIG. 2. For example, base 110 may be formed of a disposable medical grade material such as cellulose, cotton, and/or medical grade foam. Base 110 may be formed of a fibrous material that is advantageous for absorbing saliva, blood, and/or water so as to provide a drier and/or clearer operating field.

First wing 120 is positioned in a vertical orientation and is anchored to base 110 at a lower edge of first wing 120. First wing 120 spans from a position in proximity to the one or more molars of lower set of teeth 1 to a position in proximity to the one or more incisors of lower set of teeth 1, and preferably spans past a midpoint of base 110. In a preferred embodiment, first wing 120 is taller (or has a greater height) in proximity to the one or more molars of lower set of teeth 1, and is shorter (or has a lesser height) in proximity to the one or more incisors of lower set of teeth 1.

Referring to FIG. 2, first wing 120 includes a first side 121 and a second side 122. First side 121 is anchored to base 110.

Second wing 130 is also positioned in a vertical orientation and is also anchored to base 110 at a lower edge of second wing 130. Second wing 130 spans from a position in proximity to one or more molars of lower set of teeth 1 to a position in proximity to one or more incisors of lower set of teeth 1, and preferably spans past a midpoint of base 110. In a preferred embodiment, second wing 130 is taller (or has a greater height) in proximity to the one or more molars of lower set of teeth 1, and is shorter (or has a lesser height) in proximity to the one or more incisors of lower set of teeth 1.

Referring to FIG. 2, an embodiment of the dental apparatus is shown wherein second wing 130 includes a first side 131 and a second side 132. First side 131 is anchored to base 110 and to the second side 122 of first wing 120 so that a portion of second wing 130 overlaps with a portion of first wing 120 to form a continuous barrier to restrict movement of a patient's tongue. In other words, first wing 120 and second wing 130 work in coordination to provide a barrier to restrict movement of the patent's tongue. The arrangement depicted in FIG. 2 may alternatively or additionally be described as second side 122 of first wing 120 being anchored to first side 131 of second wing 130 so that first wing 120 and second wing 130 partially overlap.

Both first wing 120 and second wing 130 may be formed of a wing material that may be any material is flexible enough to conform to a tight bend created by the U-shaped lower set of teeth 1. The wing material may be disposable. For example, the wing material may be fibrous material or may be a non-woven pressed material.

As seen in FIG. 1 and FIG. 2, both first wing 120 and second wing 130 may be substantially rounded in shape and formed without any points or 90-degree angles so as to provide comfort to a patient. In a preferred embodiment, second wing 130 is a mirror image copy of first wing 120 arranged as described herein to provide a coordinated barrier to restrict movement of the patient's tongue.

In alternative embodiments of the dental apparatus, first wing 120 and second wing 130 may attach (or be simultaneously formed) to form a contiguous barrier. In other words, certain embodiments of the present invention may utilize an arrangement wherein first wing 120 and second wing 130 are formed together so that they essentially form a continuous (or contiguous) vertically oriented structure that forms a barrier to restrict movement of the patient's tongue. In such an embodiment, the continuous structure formed of first wing 120 and second wing 130 may be said to span from a position in proximity to one or more molars of lower set of teeth 1 to a position in proximity to the other molars of lower set of teeth 1. With this arrangement, the continuous structure may have a greater height in proximity to one or more molars of lower set of teeth 1 and a lesser or lower height in proximity to one or more incisors of lower set of teeth 1.

While the present invention has been illustrated and described herein in terms of a preferred embodiment and several alternatives, it is to be understood that the devices and methods described herein can have a multitude of additional uses and applications. Accordingly, the invention should not be limited to just the particular description and various drawing figures contained in this specification that merely illustrate a preferred embodiment and application of the principles of the invention.

What is claimed is:

1. An apparatus for restricting tongue movement during a dental procedure, comprising:
a base formed of flexible material capable of bending to form a U-shape for positioning the apparatus behind a lower set of teeth on a lower jaw within an oral cavity, wherein the base is cylindrical in shape;
a first wing for restricting movement of a tongue and formed of a wing flexible material, wherein the first wing is positioned in a vertical orientation to partially provide a barrier in coordination with a second wing between the lower set of teeth and the tongue and wherein a lower edge of the first wing is anchored to the base to secure the vertical orientation; and
the second wing restricting movement of the tongue and formed of the wing flexible material, wherein the second wing is positioned in a vertical orientation to partially provide the barrier in coordination with the first wing between the lower set of teeth and the tongue and wherein a lower edge of the second wing is anchored to the base to secure the vertical orientation.

2. The apparatus as recited in claim 1, wherein the first wing and the second wing overlap along a portion of the base so that the second wing is also anchored to the first wing.

3. The apparatus as recited in claim 1, wherein the flexible material is fibrous for absorbing saliva.

4. The apparatus as recited in claim 3, wherein the flexible material is cotton rolled to form the cylindrical shape.

5. The apparatus as recited in claim 1, wherein the flexible material is a disposable medical grade material.

6. The apparatus as recited in claim 1, wherein the flexible material is a non-woven pressed material.

7. The apparatus as recited in claim 1, wherein the base includes a rigid internal structure for providing structural support.

8. The apparatus as recited in claim 7, wherein the rigid internal structure is formed of aluminum.

9. The apparatus as recited in claim 1, wherein the apparatus is formed entirely of disposable materials.

10. The apparatus as recited in claim 1, wherein the base tapers at one or more ends.

11. The apparatus as recited in claim 1, wherein the wing flexible material is a disposable medical grade material.

12. The apparatus as recited in claim 1, wherein the first wing is taller in proximity to one or more molars of the lower set of teeth and shorter in proximity to one or more incisors of the lower set of teeth.

13. The apparatus as recited in claim 12, wherein the second wing is taller in proximity to the one or more molars of the lower set of teeth and shorter in proximity to the one or more incisors of the lower set of teeth.

14. The apparatus as recited in claim 1, wherein the second wing is taller in proximity to one or more molars of the lower set of teeth and shorter in proximity to one or more incisors of the lower set of teeth.

15. The apparatus as recited in claim 1, wherein the first wing and the second wing have a rounded shape to avoid irritating the oral cavity.

16. An apparatus for restricting tongue movement during a dental procedure, comprising:
a base formed of a flexible material capable of bending to form a U-shape for positioning the apparatus behind a lower set of teeth on a lower jaw within an oral cavity, wherein the base is cylindrical in shape;
a first wing for restricting movement of a tongue and formed of a wing flexible material, wherein the first wing has a first side and a second side and is positioned in a vertical orientation; and
a second wing restricting movement of the tongue and formed of the wing flexible material, wherein the second wing has a first side and a second side and is positioned in a vertical orientation;
wherein the first side of the first wing is anchored to the base;
wherein the first side of the second wing is anchored to the base and to the first wing; and
wherein the second side of the first wing is anchored to the first side of the second wing so that the first wing and the second wing partially overlap.

17. The apparatus as recited in claim 16, wherein the apparatus is formed entirely of disposable materials.

18. The apparatus as recited in claim 16, wherein the first wing is taller in proximity to one or more molars of the lower set of teeth and shorter in proximity to one or more incisors of the lower set of teeth.

19. The apparatus as recited in claim 18, wherein the second wing is taller in proximity to the one or more molars of the lower set of teeth and shorter in proximity to the one or more incisors of the lower set of teeth.

20. The apparatus as recited in claim 15, wherein the second wing is taller in proximity to one or more molars of the lower set of teeth and shorter in proximity to one or more incisors of the lower set of teeth.
